(19) United States
(12) Patent Application Publication
(10) Pub. No.: US 2006/0095456 A1
(43) Pub. Date: May 4, 2006

(54) System and method for retrieving structured document

(76) Inventors: Miyuki Sakai, Fuchu-shi (JP); Hitoshi Tanigawa, Higashiyamato-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/078,307

(22) Filed: Mar. 14, 2005

(30) Foreign Application Priority Data
Oct. 29, 2004 (JP) 2004-316084

(51) Int. Cl. G06F 17/00

(52) U.S. Cl. 707/101

(57) ABSTRACT

A structured document retrieval system includes a structured document database which manages a structured document by a tree structure including a plurality of hierarchical nodes, a unit which receives a traverse request from a client, the traverse request including base point node designation information to designate one of nodes in the structured document database as a base point node corresponding to a base point for retrieval and relative location information to designate a location of a traverse destination node relative to the base point node, and a traverse processing unit which performs a traverse process to move from the one of nodes designated by the base point node designation information to another one of the nodes in accordance with the relative location information, and acquires data corresponding to the traverse destination node from the structured document database.

### CROSS-REFERENCE TO RELATED APPLICATIONS

This application is based upon and claims the benefit of priority from prior Japanese Patent Application No. 2004-316084, filed Oct. 29, 2004, the entire contents of which are incorporated herein by reference.

### BACKGROUND OF THE INVENTION

1. Field of the Invention

The present invention relates to a system and a method for retrieving a structured document including a plurality of hierarchical nodes, such as an extensible markup language (XML) document. More specifically, the invention relates to a structured document retrieval system, a structured document retrieval method and a program for retrieving data about a target node in a structured document from a structured document database that stores structured documents.

2. Description of the Related Art

A document having a logical structure is generally called a structured document. This logical structure is represented by tags described in the document. Such a structure document is suitable to be processed by a computer.

An extensible markup language (XML) is widely used as a means for describing data using tags. The XML has the advantages that data can hierarchically be structured by significant tags and the structure can freely be extended. A document described with the XML is called an XML document. The XML document is known as a typical structured document that is logically represented by a tree structure using the tags. The XML document includes a plurality of hierarchical nodes that constitute a tree structure. These nodes are elements of the XML document.

A database that is capable of storing an XML document with the advantages of the XML and retrieving an arbitrary logical structure (document structure) or an arbitrary element from the XML document is called an XML database (XMLDB). The XML database can be searched by an XPath or an XQuery. The XPath and XQuery are languages developed by the World Wide Web Consortium (W3C) in order to retrieve an arbitrary element (node) from one or more XML documents.

The XPath is used to retrieve a target node from an XML document by designating a location of the node by an absolute location pass from a root node. Retrieval using the XPath is called XPath retrieval. If the XPath retrieval is performed using a description to designate the absolute location pass of a target node, an application (application program) can acquire data about the target node (XML data) from the result of the retrieval. The XPath retrieval can be performed for all descendants of a node to be retrieved. For example, the following designation can be done: a node to be retrieved and its all descendant nodes having a tag name “book”. Since this retrieval is pattern matching for all descendant nodes (a kind of full-text retrieval), the absolute location pass of each of the descendant nodes need not be described. This retrieval is called XPath descendant node retrieval.

Jpn. Pat. Appln. KOKAI Publication No. 2001-167087 (paragraphs 0020 to 0026) discloses a technology for using a query tree that represents a sibling relationship by a tree structure in order to retrieve a document having a complicated structure, especially a structured document having a sibling relationship. This is a kind of XPath extension technology in which a query in itself is represented by a tree structure.

When an application requires part of an XML document stored in an XML database, preprocessing such as sorting and filtering is often performed using data in the XML document. The application has to acquire not only data corresponding to an essentially required part but also data that falls within a range including the part used for the preprocessing and process the acquired data.

However, it is generally difficult to designate only the minimum required data including the part used for the preprocessing by the XPath. Assume here that an operator wishes to retrieve the “first names” of “authors” of “books” whose “last names” are “Stevens” in order of “prices” of the “books.” The XML database stores three XML documents and their tree structure is the same as that of three XML documents 111, 112 and 113 shown in FIG. 7 that is directed to an embodiment of the present invention described later. See FIG. 7 if necessary. The parent node (uppermost node) of each of the three XML documents is “book.” Since the retrieval requirement (retrieval condition) is complicated, only the minimum required data including the part used for the preprocessing cannot be designated by the XPath.

In order to meet the above retrieval requirements, the above XPath descendant node retrieval is required to acquire data from the parent node “book” common to the three XML documents and its all descendant nodes. If the XPath descendant node retrieval is simply used, not all necessary information can be acquired as described above. Information including data necessary for preprocessing needs to be widely acquired. Thus, the range of data to be retrieved is extended and a lot of time is required for data acquisition. Further, even though the operator obtains a result of the retrieval, he or she cannot know a halfway-location pass or find which part of the XML documents hits.

As a process on the application side after a node is specified by the retrieval, a data acquisition request such as “one-lower hierarchical level data of the retrieved node,” which is based on a relationship in location relative to the retrieved node, is made a lot. However, the operator cannot continue the retrieval because he or she cannot obtain any location pass close to the retrieved node.

The technology using a query tree (XPath extension technology), disclosed in the above Publication No. 2001-167087 allows nodes having a sibling relationship to be retrieved, unlike the normal XPath retrieval. However, nodes having a relationship that is more complicated than the sibling relationship, such as nodes at different hierarchical levels, cannot be retrieved. In the retrieval technology using a query tree, too, information including data necessary for the above preprocessing needs to be widely acquired. Thus, the range of data to be retrieved is extended and a lot of time is required for data acquisition.

### BRIEF SUMMARY OF THE INVENTION

According to an embodiment of the present invention, there is provided a structured document retrieval system comprising a structured document database which manages a structured document by a tree structure including a plurality of hierarchical nodes, means for receiving a traverse request from a client, the traverse request including base point node designation information to designate one of nodes in the structured document database as a base point node corresponding to a base point for retrieval and relative location information to designate a location of a traverse destination node relative to the base point node, and traverse processing means for performing a traverse process to move from the one of nodes designated by the base point node designation information to another one of the nodes in accordance with the relative location information, and acquiring data corresponding to the traverse destination node from the structured document database.

Additional advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a configuration of a structured document retrieval system having a traverse function according to an embodiment of the present invention;

FIG. 2 is a conceptual diagram of the data structure of an XMLDB provided in the structured document retrieval system shown in FIG. 1;

FIG. 3 is a diagram showing an example of the data structure of the XMLDB in which one XML document is stored;

FIG. 4 is a diagram showing an example of the data structure of the XMLDB in which three XML documents are stored;

FIG. 5 is a flowchart showing a procedure for performing a retrieval process including a traverse process in the structured document retrieval system shown in FIG. 1;

FIG. 6 is a chart of a sequence of communications between a structured document retrieving client and the structured document retrieval system shown in FIG. 1; and

FIG. 7 is an illustration of the traverse process in the structured document retrieval system shown in FIG. 1.

### DETAILED DESCRIPTION OF THE INVENTION

An embodiment of the present invention will be described with reference to the accompanying drawings.

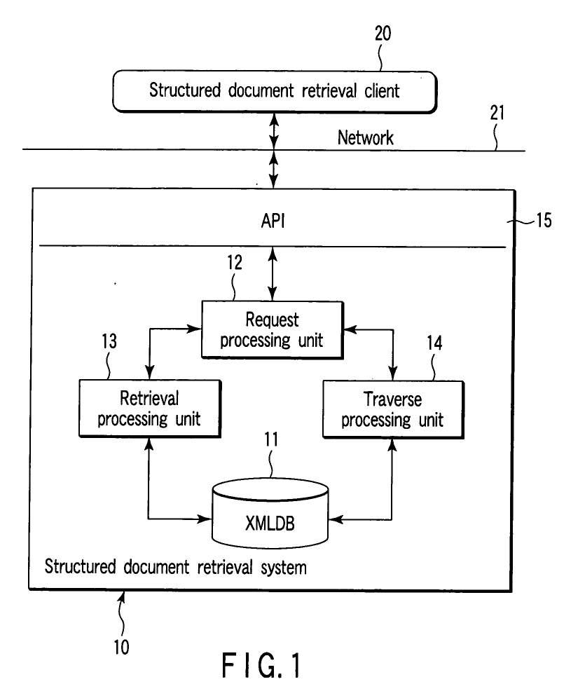

FIG. 1 is a block diagram showing a configuration of a structured document retrieval system 10 having a traverse function according to an embodiment of the present invention. This system 10 is connected to a structured document retrieving client (structured document retrieving client's terminal) 20 via a network 21 such as a local area network (LAN). An application using the system 10 runs on the client 20. The system 10 includes an XML database (XMLDB) 11, a request processing unit 12, a retrieval processing unit 13, a traverse processing unit 14 and an application interface (API) 15.

The XMLDB 11 is a database for storing an XML document as a structured document. The XML document includes a hierarchical set of nodes (elements). The XMLDB 11 manages the XML document by a tree structure including the hierarchical nodes. The request processing unit 12 receives a retrieval request from the client 20. When the retrieval request received by the unit 12 is an XPath retrieval request including a location pass to a node to be retrieved as a retrieval condition (location pass designation retrieval request), the retrieval processing unit 13 retrieves the node in the XMLDB 11 in accordance with the XPath.

The traverse processing unit 14 follows the hierarchical nodes from an arbitrary base point node in the XMLDB 11 and moves a current node from the arbitrary base point node to its parent, child or sibling node when the retrieval request received by the request processing unit 12 is a traverse request. This is called a traverse process. The traverse request includes base point node designation information for designating one of the nodes in the XMLDB 11 as the base point (starting point) node for retrieval and relative location information for designating a location of a traverse destination node relative to the base point node. As the relative location information, direction information indicative of a traverse direction relative to the base point node is used. Using this direction information, one of a parent node, a child node, a preceding-sibling node and a following-sibling node is designated as a traverse destination node to be retrieved.

The API 15 interfaces between an application running on the structured document retrieving client 20 and the structured document retrieval system 10. If the client 20 is directly connected to the system 10 not through the network, the API 15 can be provided in the client 20.

The request processing unit 12, retrieval processing unit 13, a traverse processing unit 14 and API 15 are implemented by a specific software program (e.g., a structured document database management program) installed in a computer such as a database server computer. When the computer (CPU) reads and executes the software program, it performs a process of each of the units 13 to 15 and API 15. This program can be stored in advance in a computer-readable storage medium and distributed. It also can be downloaded (distributed) through a network.

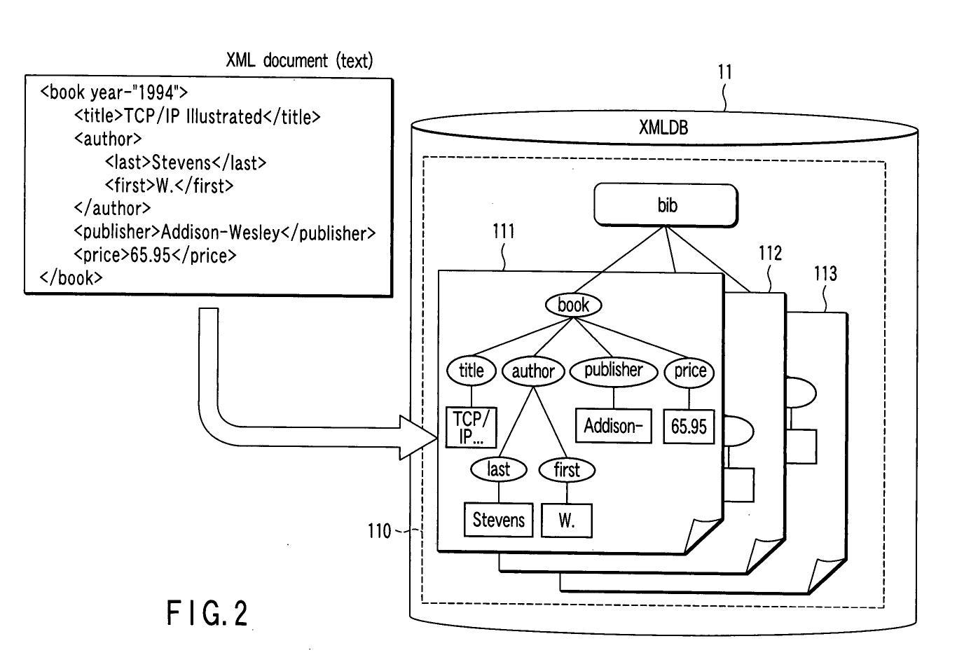

FIG. 2 is a conceptual diagram of the structure of data managed by the XMLDB 11. Referring to FIG. 2, the XMLDB 11 stores three XML documents 111, 112 and 113. Note here that the XML documents 111, 112 and 113 are each stored as a partial tree of one tree structure having a node called “bib” as a root. In other words, the XMLDB 11 stores one virtual XML document 110 having a tree structure and manages the actual XML documents 111, 112 and 113 as partial trees of the XML document 110.

The “bib” node is the uppermost node of the XML document, or the root node. Of the XML documents 111, 112 and 113, for example, the XML document 111 is associated with the virtual XML document 110 such that the uppermost node (“book” node) of the XML document 111 and the “bib” node have a parent-child relationship. In this association, the “bib” node is a parent node, while the uppermost node (“book” node) of the XML document 111 is a child node. This is true of the relationship between the “bib” node and the uppermost node of each of the XML documents 112 and 113. The uppermost nodes of the XML documents 111, 112 and 113 are associated to have a sibling relationship. Assuming here that the XML documents 111, 112 and 113 are stored in the XMLDB 11 in this order, the uppermost node of the XML document 112 becomes a following-sibling node of the uppermost node of the XML document 111, and the uppermost node of the XML document 113 becomes a following-sibling node of the uppermost node of the XML document 112. The nodes (elements) of the XML document 111, those of the XML document 112 and those of the XML document 113 constitute the tree structure of the virtual XML document 110 in the XMLDB 11.

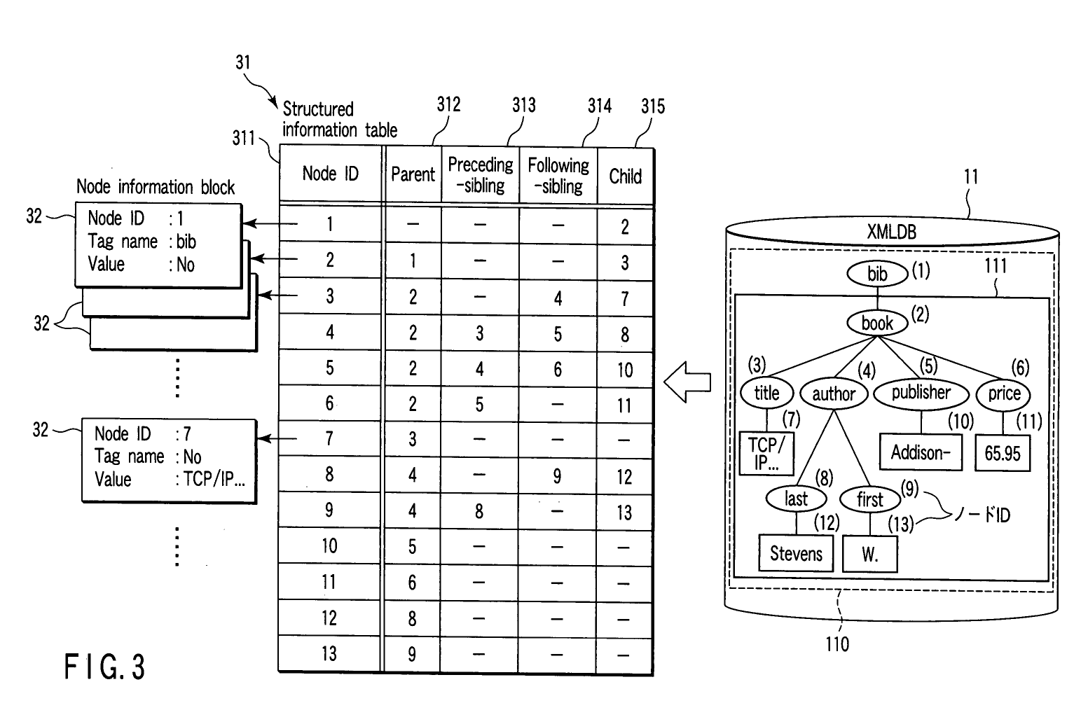

FIG. 3 shows an example of the data structure of the XMLDB 11 in which the XML document 111 shown in FIG. 2 is stored. In FIG. 3, the XML document 111 is a single partial tree of the tree structure of the XML document 110. Referring to FIG. 3, the XMLDB 11 stores a structure information table 31 for managing the tree structure of the XML document 110 for each of the nodes (elements) that constitute the tree structure and a node information block 32 for managing information of each of the nodes (elements) of the XML document 110. The number of entries of the table 31 is equal to that of nodes of the XML document 110, as is the number of node information blocks 32. A unique number, i.e., a node ID is assigned to each of the nodes.

The i-th (i=1, 2, . . . ) entry of the structure information table 31 is formed of a node ID field (item) 311, a parent node field 312, a preceding-sibling node field 313, a following-sibling node field 314 and a child node field 315 that specify a node ID (ID=i) of node i, that of a parent node of node i, that of a preceding-sibling node of node i, that of a following-sibling node of node i and that of a child node of node i, respectively. In other words, each of entries of the table 31 is used to hold information indicating a relationship in location in the tree structure of a node corresponding to the entry. If the node i does not include a parent node, a preceding-sibling node, a following-sibling node or a child node, a specific value (“−”in FIG. 3), which indicates that there is no corresponding node, is set in the field corresponding to the i-th entry in the structure information table 31.

In the present embodiment, when the node i includes a plurality of child nodes, only the node ID of the eldest son node is set in the child node field 315 of the i-th entry of the structure information table 31. For example, the child nodes of a “book” node of node ID 2 are a “title” node corresponding to node ID 3, an “author” node corresponding to node ID 4, a “publisher” node corresponding to node ID 5 and a “price” node corresponding to node ID 6. The “title” node indicates the eldest son. The node ID 3 of the “title” node is set in the child node field 315 of the second entry of the table 31.

Each of the node information blocks 32 is used to hold information (node information) unique to its corresponding node. Each of the blocks 32 holds a node ID, a tag name of the node and a value (element value) of the node. There is a possibility that the value (size) will greatly vary from node to node. In order to fix the size of a node information block 32, the value of the node can be held separately from the block 32, and a pointer indicating an area in which the value of the node is stored can be held in the block 32.

The information of each of entries in the structure information table 31 and the node information block 32 corresponding to the entry are created when an XML document is stored in the XMLDB 11. Note that an XML document is not stored in the XMLDB 11 in text format or binary format unique to the system in the present embodiment. In other words, the XML document is stored as a partial tree of the tree structure having a “bib” node as the root thereof. More specifically, both information (structure information) indicative of the location of each node (element) of an XML document in the tree structure and information (node information) unique to each node of the XML document are stored in the XMLDB 11. The structure information is used to manage a parent-child and preceding-sibling and following-sibling relationship between nodes in the XMLDB 11. For the sake of brevity, storing the structure information and node information about the XML document in the XMLDB 11 may sometimes be described as storing the XML document in the XMLDB 11.

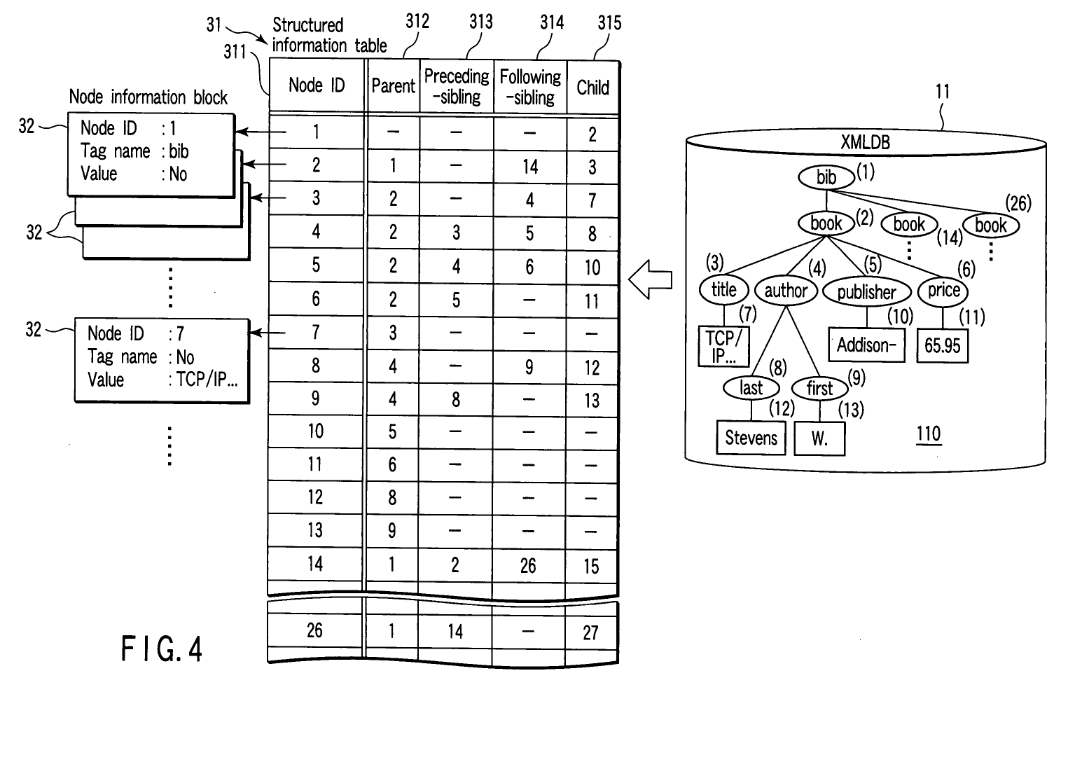

FIG. 4 shows an example of the data structure of the XMLDB 11 in which the XML documents 111, 112 and 113 are stored in this order. The XML documents 112 and 113 have the same tree structure as that of the XML document 111 and their uppermost nodes are “book” nodes. The “book” nodes of the XML documents 112 and 113 are assigned with their respective node IDs 14 and 26 as shown in FIG. 4. The “book” node with the node ID 14 is a following-sibling node of the “book” node with the node ID 2, and the “book” node with the node ID 26 is a following-sibling node of the “book” node with the node ID 14. Thus, the following-sibling node field 314 of the second entry in the structure information table 31, which corresponds to the “book” node of node ID 2, is updated from “−” indicating no following-sibling nodes (see FIG. 3) to the node ID (ID=14) of “book” node of the XML document 112. When the XML document 112 is stored in the XMLDB 11 as a partial tree of the XML document 110, the entries whose number (e.g. twelve) coincides with that of nodes of the XML document 112, are added to the structure information table 31. Similarly, when the XML document 113 is stored in the XMLDB 11 as a partial tree of the XML document 110, the entries whose number (e.g. twelve) coincides with that of nodes of the XML document 113, are added to the structure information table 31.

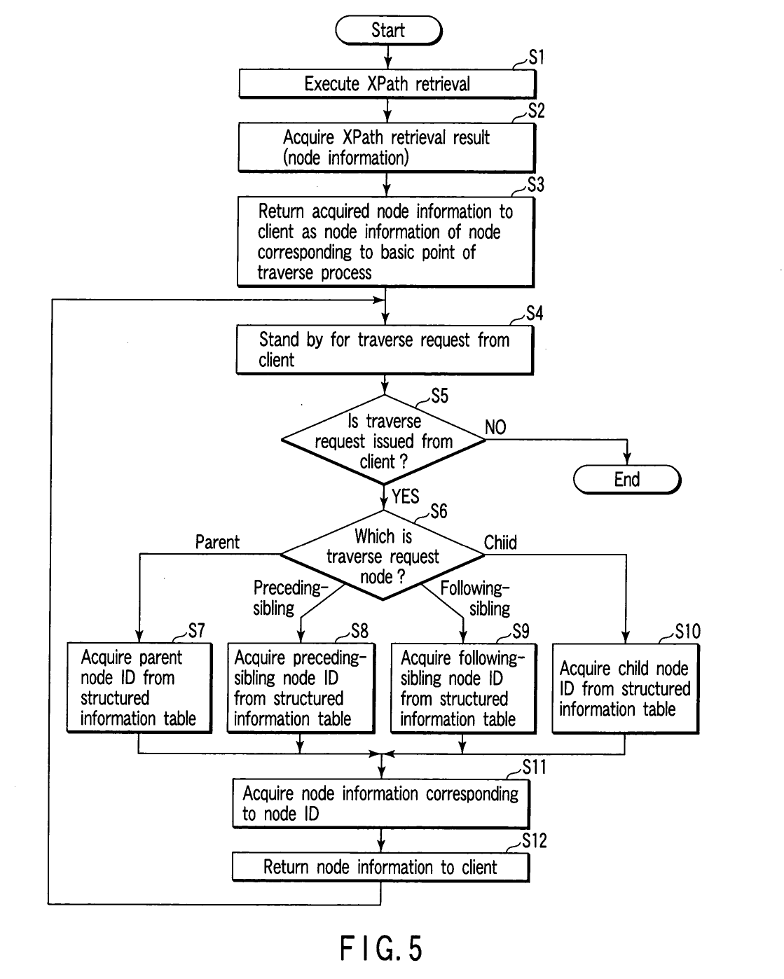

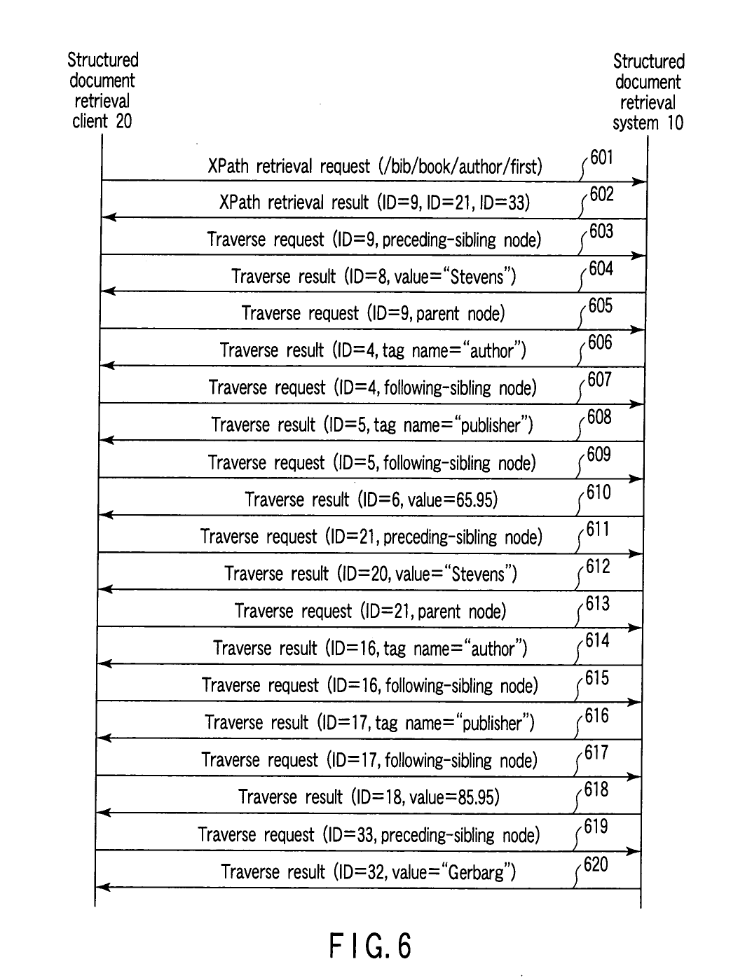

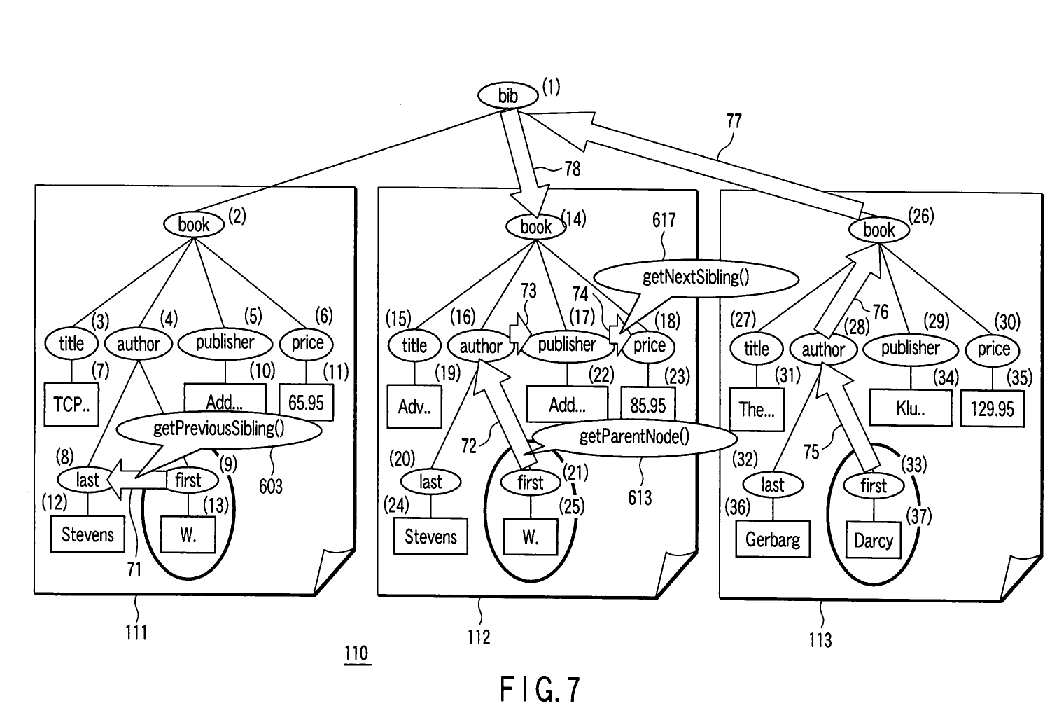

A retrieval process including a traverse process in the structured document retrieval system 10 shown in FIG. 1 will be described with reference to FIGS. 5 to 7. FIG. 5 is a flowchart showing a procedure for performing the retrieval process including a traverse process in the structured document retrieval system 10. FIG. 6 is a sequence chart showing a procedure for communications between a structured document retrieving client 20 and the structured document retrieval system 10. FIG. 7 is an illustration of the traverse process in the structured document retrieval system 110, which traverses the virtual XML document 110 having the XML documents 111, 112 and 113 as partial trees of the tree structure.

Assume first that a user requests the structured document retrieval client 20 to acquire the “first names” of “authors” of “books” whose “last names” are “Stevens” in order of “prices” of the “books.” As described above, only the minimum required data that meets the request cannot be designated by the XPath.

The structured document retrieval client 20 generates an XPath given by the following equation in order to retrieve the “first names” of “authors” of “books”:

XPath=/bib/book/author/first

The client 20 issues a retrieval request (XPath retrieval request) 601 to the structured document retrieval system 10. This request 601 is received by the API 15 of the system 10 and transferred to the request processing unit 12. In the present embodiment, the XPath is used as a query language for making a request to retrieve necessary data from the XMLDB 11. However, XQuery can be used as a query language.

The request processing unit 12 receives a retrieval request from the client 20. If the retrieval request is the XPath retrieval request 601, the unit 12 sends the request 601 to the retrieval processing unit 13. Then, the unit 13 executes the XPath retrieval in accordance with the retrieval request 601 (step S1). The unit 13 acquires node information of a node (“first” node) designated by the XPath as an XPath retrieval result 602 (step S2). Assume here that the node information acquired in step S2 includes a node ID of the “first” node and a value of the child node of the “first” node, or a “first name.” Since, however, the “first” node may include a node that does not meet a user's retrieval request, the node information of the “first” node acquired in step S2 can be set to exclude a value of the child node of the “first” node. In this case, the structured document retrieval client 20 has only to request the system 10 to acquire a value of the child node (i.e., “first name”) of only the “first” node, which turns out to be consistent with the user's retrieval requirement, using a node ID included in the node information of the “first” node.

In the example shown in FIG. 7, the node information of the “first” nodes (i.e., nodes with node IDs 9, 21 and 33) of the XML documents 111, 112 and 113 are acquired in step S2. It is apparent from FIG. 7 that the node information of the “first” node of node ID 9 includes a value “W” (“first name”) of the child node as well as the node ID 9. The node information of the “first” node of node ID 21 includes a value “W” (“first name”) of the child node as well as the node ID 21. The node information of the “first” node of node ID 33 includes a value “Darcy” (“first name”) of the child node as well as the node ID 33. The retrieval processing unit 13 returns the node information of all the nodes acquired as the XPath retrieval result (a set of XPath retrieval results) 602 to the structured document retrieval client 20 as the node information of a node corresponding to the base point of the traverse process performed by the traverse processing unit 14 through the request processing unit 12 and the API 15 (Step S3).

Upon receiving the XPath retrieval result 602 or the node information of the “first” nodes (i.e., nodes with node IDs 9, 21 and 33) each corresponding to the base point of the traverse process, the structured document retrieval client 20 uses a specific retrieval request called a traverse request (traverse command) described below in order to acquire information of “last” nodes as a filtering condition and information of “price” nodes as a sorting condition. The traverse request includes the node ID of the current base point node and direction information indicating a traverse direction. In the present embodiment, the traverse direction that can be designated by the traverse request is one selected from the parent, preceding-sibling, following-sibling and child. In other words, the traverse request can instruct a traversal from the current base point node to the parent node, preceding-sibling node, following-sibling node or child node. The traverse request is used not to designate an absolute location in the tree structure indicating the logical structure of one virtual XML document 110 stored in the XMLDB 11 (using a location pass) but to designate a location, such as the parent node, preceding-sibling node, following-sibling node and child node, relative to the base point node.

In the present embodiment, the base point nodes of the traverse process of which the structured document retrieval system 10 notifies the structured document retrieval client 20 are the “first” nodes with node IDs 9, 21 and 33. The client 20 requests the system 10 to perform the traverse process in sequence based on the “first” nodes.

The “last” nodes are preceding-sibling nodes viewed from the “first” nodes corresponding to the current base point nodes. The current base point nodes are the “first” nodes with node IDs 9, 21 and 33 as described above. The client 20 issues a traverse request (traverse command) 603 for instructing a traverse to the preceding-sibling node to the system 10 based on the “first” node with node ID 9. This traverse request is called a “get Previous Sibling” command. In FIG. 6, the current base point node and traverse direction, designated by the traverse request, are represented by the following format: “node ID of current base point node, traverse direction.”

When the XPath retrieval result 602 is returned to the client 20, the request processing unit 12 stands by for a traverse request as the next retrieval request from the client 20 (step S4). If the client 20 issues a traverse request (step S5), the unit 12 receives the traverse request and sends it to the traverse processing unit 14. The unit 14 analyzes the traverse request and determines which of the parent, preceding-sibling, following-sibling and child nodes corresponds to the traverse direction from the base point node or the traverse destination node (step S6).

If the traverse destination node is the parent node, i.e., the traverse direction indicates the parent, the traverse processing unit 14 refers to the entry in the structured information table 31 which correspond to the base point node designated by the traverse request and acquires the node ID of the parent node of the base point node from the parent node field 312 of the entry (step S7). If the traverse destination node is the preceding-sibling node, the unit 14 refers to the entry in the table 31 which correspond to the base point node designated by the traverse request and acquires the node ID of the preceding-sibling node of the base point node from the preceding-sibling node field 313 of the entry (step S8). If the traverse destination node is the following-sibling node, the unit 14 refers to the entry in the table 31 which correspond to the base point node designated by the traverse request and acquires the node ID of the following-sibling node of the base point node from the following-sibling node field 314 of the entry (step S9). If the traverse destination node is the child node, the unit 14 refers to the entry in the table 31 which correspond to the base point node designated by the traverse request and acquires the node ID of the child node of the base point node from the child node field 315 of the entry (step S10). Then, the unit 14 refers to the node information block 32 unique to the acquired node ID and acquires node information of a node designated by the node ID (step S11). If the designated node does not have a value but its child node has a value, the value is acquired as node information.

The traverse request 603 that is first issued from the client 20 to the system 10 gives an instruction to traverse to the preceding-sibling node from the “first” node with node ID 9. The preceding-sibling node of the “first” node with node ID 9 is the “last” node with node ID 8 as indicated by arrow 71 in FIG. 7. In step S11, therefore, the traverse processing unit 14 performs the traverse process to move a current node from the “first” node with node ID 9 to the “last” node with node ID 8 and acquires the node information of the “last” node as data of the traverse destination node. The value (“last name”=“Stevens”) of the child node (with node ID 9) of the “last” node with node ID 8 is also acquired as part of the node information of the “last” node.

The traverse processing unit 14 returns the acquired node information to the client 20 through the unit 12 and API 15 as a result (traverse result) 604 of the traverse process (retrieval process) performed by the traverse request 603 (step S12). Then, the unit 12 stands by for the next traverse request from the client 20 (step S4).

The traverse result 604 includes “Stevens” as “last name.” The client 20 can acquire information of the “last” node as a filtering condition using a traverse request to move to a preceding-sibling node (“last” node) from the “first” node with node ID 9. Based on the traverse result 604, the client 20 determines that the preceding-sibling node of the “first” node with node ID 9 or the “last” node with node ID 8 satisfies the filtering condition. The client 20 issues the following traverse requests in sequence in order to acquire information of the “price” node as a sorting condition based on the “first” node with node ID 9. First, the client 20 issues to the system 10 a traverse request 605 for giving an instruction to traverse to the parent node from the “first” node with node ID 9. This traverse request is called a “get Parent Node” command.

The traverse processing unit 14 of the system 10 refers to the ninth entry in the table 31 which corresponds to the “first” node with node ID 9 in response to the traverse request 605 from the client 20 and acquires the node ID of the parent node of the “first” node from the parent field 312 of the entry (steps S6 and S7). As is apparent from FIG. 7, the parent node of the “first” node is the “author” node with node ID 4. The unit 14 acquires the node ID 4 in response to the traverse request 605. The unit 14 moves the current node to the “author” node with the node ID 4 from the “first” node with the node ID 9, refers to the node information block 32 unique to the node ID 4, and acquires the node information of the “author” node as data of the traverse destination node (step S11). This node information includes the node ID 4 and the tag name “author.” The node information is returned to the client 20 as a traverse result 606 obtained by the traverse request 605 (step S12).

Upon receiving the traverse result 606, the client 20 issues to the system 10 a traverse request 607 for giving an instruction to traverse to the following-sibling node from the “author” node with node ID 4 included in the traverse result 606. This traverse request is called a “get Next Sibling” command.

The traverse processing unit 14 of the system 10 refers to the fourth entry in the table 31 which corresponds to the “author” node with node ID 4 in response to the traverse request 607 from the client 20 and acquires the node ID of the following-sibling node of the “author” node from the following-sibling field 314 of the entry (steps S6 and S9). As is apparent from FIG. 7, the following-sibling node of the “author” node is the “publisher” node with node ID 5. The unit 14 acquires the node ID 5 in response to the traverse request 607. The unit 14 moves the current node to the “publisher” node from the “author” node, refers to the node information block 32 unique to the node ID 5, and acquires the node information of the “publisher” node as data of the traverse destination node (step S11). This node information includes the node ID 5 and the tag name “publisher.” The node information is returned to the client 20 as a traverse result 608 obtained by the traverse request 607 (step S12).

Upon receiving the traverse result 608, the client 20 issues to the system 10 a traverse request 609 for giving an instruction to traverse to the following-sibling node from the “publisher” node with node ID 5 included in the traverse result 608.

The traverse processing unit 14 of the system 10 refers to the fifth entry in the table 31 which corresponds to the “publisher” node with node ID 5 in response to the traverse request 609 from the client 20 and acquires the node ID of the following-sibling node of the “publisher” node from the following-sibling field 314 of the entry (steps S6 and S9). As is apparent from FIG. 7, the following-sibling node of the “publisher” node is the “price” node with node ID 6. The unit 14 acquires the node ID 6 in response to the traverse request 609. The unit 14 moves the current node to the “price” node from the “publisher” node, refers to the node information block 32 unique to the node ID 6, and acquires the node information of the “price” node as data of the traverse destination node (step S11). The unit 14 also acquires a value (or “price”) “65.9” of the child node of the “price” node. The unit 14 includes this value in the node information of the “price” node. The node information is returned to the client 20 as a traverse result 610 obtained by the traverse request 609 (step S12).

As described above, the structured document retrieval client 20 can acquire information of the “price” node as a sorting condition using a traverse request to move to a parent node (“author” node), a following-sibling node (“publisher” node) of the parent node, and a following-sibling node (“price” node) of the following-sibling node from the “first” node with node ID 9.

The client 20 issues the following traverse request 611 to the structured document retrieval system 10 in order to acquire information of the “last” node as a filtering condition based on the “first” node with node ID 21. The traverse request 611 is an instruction to traverse to the preceding-sibling node from the “first” node with node ID 21.

The traverse processing unit 14 of the system 10 refers to the entry in the table 31 which corresponds to the “first” node with node ID 21 in response to the traverse request 611 from the client 20 and acquires the node ID of the preceding-sibling node of the “first” node from the preceding-sibling field 313 of the entry (steps S6 and S8). As is apparent from FIG. 7, the preceding-sibling node of the “first” node is the “last” node with node ID 20. The unit 14 acquires the node ID 20 in response to the traverse request 611. The unit 14 moves the current node to the “last” node from the “first” node, refers to the node information block 32 unique to the node ID 20, and acquires the node information of the “last” node as data of the traverse destination node (step S11). The unit 14 also acquires a value (or “last name”) “Stevens” of the child node of the “last” node. The unit 14 includes this value in the node information of the “last” node. The node information is returned to the client 20 as a traverse result 612 obtained by the traverse request 611 (step S12).

As described above, the traverse result 612 includes “Stevens” as “last name.” The structured document retrieval client 20 can acquire information of the “last” node as a filtering condition using a traverse request to move to the preceding-sibling node (“last” node) from the “first” node with node ID 21. Based on the traverse result 612, the client 20 determines that the preceding-sibling node of the “first” node with node ID 21 or the “last” node with node ID 22 satisfies the filtering condition. The client 20 issues the following traverse requests in sequence in order to acquire information of the “price” node as a sorting condition based on the “first” node with node ID 21. First, the client 20 issues to the system 10 a traverse request 613 for giving an instruction to traverse to the parent node from the “first” node with node ID 21.

The traverse processing unit 14 of the system 10 refers to the structured information table 31 in response to the traverse request 613 from the client 20 and acquires the node ID of the parent node of the “first” node with node ID 21 as in the case of the traverse request 605 (steps S6 and S7). As indicated by arrow 72 in FIG. 7, the parent node of the “first” node is the “author” node with node ID 16. The unit 14 acquires the node ID 16 in response to the traverse request 613. The unit 14 moves the current node to the “author” node from the “first” node and acquires the node information of the “author” node as data of the traverse destination node (step S11). This node information includes the node ID 16 and the tag name “author.” The node information is returned to the client 20 as a traverse result 614 obtained by the traverse request 613 (step S12).

Upon receiving the traverse result 614, the client 20 issues to the system 10 a traverse request 615 for giving an instruction to traverse to the following-sibling node from the “author” node with node ID 16 included in the traverse result 614. The traverse processing unit 14 of the system 10 refers to the structured information table 31 in response to the traverse request 615 from the client 20 and acquires the node ID of the following-sibling node of the “author” node with node ID 16 as in the case of the traverse request 607 (steps S6 and S9). As indicated by arrow 73 in FIG. 7, the following-sibling node of the “author” node is the “publisher” node with node ID 17. The unit 14 acquires the node ID 17 in response to the traverse request 615. The unit 14 moves the current node to the “publisher” node from the “author” node and acquires the node information of the “publisher” node as data of the traverse destination node (step S11). This node information includes the node ID 17 and the tag name “publisher.” The node information is returned to the client 20 as a traverse result 616 obtained by the traverse request 615 (step S12).

Upon receiving the traverse result 616, the client 20 issues to the system 10 a traverse request 617 for giving an instruction to traverse to the following-sibling node from the “publisher” node with node ID 17 included in the traverse result 616. The traverse processing unit 14 of the system 10 refers to the structured information table 31 in response to the traverse request 617 from the client 20 and acquires the node ID of the following-sibling node of the “publisher” node with node ID 17 as in the case of the traverse request 609 (steps S6 and S9). As indicated by arrow 74 in FIG. 7, the following-sibling node of the “publisher” node is the “price” node with node ID 18. The unit 14 acquires the node ID 18 in response to the traverse request 617. The unit 14 moves the current node to the “price” node from the “publisher” node and acquires the node information of the “price” node as data of the traverse destination node (step S11). The unit 14 also acquires a value (or “price”) “85.95” of the child node of the “price” node. The unit 14 includes this value in the node information of the “price” node. The node information is returned to the client 20 as a traverse result 618 obtained by the traverse request 617 (step S12).

As described above, the structured document retrieval client 20 can acquire information of the “price” node as a sorting condition using a traverse request to move to a parent node (“author” node), a following-sibling node (“publisher” node) of the parent node, and a following-sibling node (“price” node) of the following-sibling node from the “first” node with node ID 21.

The client 20 issues the following traverse request 619 to the structured document retrieval system 10 in order to acquire information of the “last” node as a filtering condition based on the “first” node with node ID 33. The traverse request 619 is an instruction to traverse to the preceding-sibling node from the “first” node with node ID 33.

The traverse processing unit 14 of the system 10 refers to the structured information table 31 in response to the traverse request 619 from the client 20 and acquires the node ID of the preceding-sibling node of the “first” node with node ID 33 as in the case of the traverse request 603 (steps S6 and S8). As is apparent from FIG. 7, the preceding-sibling node of the “first” node is the “last” node with node ID 32. The unit 14 acquires the node ID 32 in response to the traverse request 619. The unit 14 moves the current node to the “last” node from the “first” node, refers to the node information block 32 unique to the node ID 32, and acquires the node information of the “last” node as data of the traverse destination node (step S11). The unit 14 also acquires a value (or “last name”) “Gerberg” of the child node of the “last” node. The unit 14 includes this value in the node information of the “last” node. The node information is returned to the client 20 as a traverse result 620 obtained by the traverse request 619 (step S12).

The traverse result 620 includes “Gerberg” as “last name” and, in other words, it does not include “Stevens” as “last name.” Based on the traverse result 620, the structured document retrieval client 20 determines that the preceding-sibling node of the “first” node with node ID 33 or the “last” node with node ID 32 does not satisfy the filtering condition. The client 20 completes the issuance of the traverse request. The request processing unit 12 of the system 10 completes the traverse process in the system 10 if the client 20 does not issue a traverse request when a given period of time elapses (step S5) since the unit 12 stands by for the traverse request (step S4). Even when the client 20 requests the unit 12 to complete a traverse process, the unit 12 completes it in the system 10.

In the present embodiment, it is possible to achieve a traverse process for freely moving from each of nodes obtained by an XPath retrieval to the parent node, child node, preceding-sibling node, or following-sibling node. This traverse process allows minimum required data for a sorting process or a filtering process to be retrieved.

The actual XML documents or the XML documents 111, 112 and 113 are managed as partial trees of one virtual XML document 110 in the XMLDB 11, as is apparent from FIGS. 4 and 7. The current node can thus move not only in the tree structure (partial tree) of each of the XML documents 111, 112 and 113, but also from one XML document to another XML document through the traverse process whose base point node is a node (“first” node with node ID 33) specified by the XPath retrieval, as indicated by arrows 75 to 78 in FIG. 7. In other words, a traverse retrieval can be performed for a plurality of actual XML documents managed as partial trees of one virtual XML document 110. In FIG. 7, the current node moves from the “book” node of the XML document 113 to the “book” node of the XML document 112 via the “bib” node. If a traverse request is issued to move the current node from the “book” node of the XML document to the preceding-sibling node, the current node can directly move from the “book” node of the XML document 113 to that of the XML document 112.

XML has a concept of “attribute” of a “tag” (element). The “attribute” (attribute node) is usually separated from the parent-child and sibling relationship, unlike the “tag” (tag node) in the field of XML or document object model (DOM). In the following XML document as shown in FIG. 2, however, the “year” node that is the attribute of the “book” node can be considered to be one child node of the “book” node, like a tag node such as the “title” node and the “author” node.
<book year=“1965”>
   <title> . . . </title>
   <author> . . . </author>

Considering the attribute node to be a child node (e.g., eldest-son node) of a tag node corresponding to the attribute node, the attribute node can be processed in the same manner that any tag node is.

For the sake of brevity, the above embodiment is based on the premise that the XML documents 111, 112 and 113 have the same tree structure. In the traverse process, however, a traverse destination (target for retrieval) is designated by information of location, such as a parent node and a child node, relative to the current base point node and thus the XMLDB 11 can be scanned freely without any consciousness about the descriptions of a location pass. Even though the XML documents 111, 112 and 113 do not have the same tree structure or the location pass is unclear, the nodes close to a node retrieved by the XPath retrieval can be retrieved.

In the above embodiment, the structured document retrieval client 20 issues traverse requests in sequence to the structured document retrieval system 10. If the client 20 notices the tree structure of the XML documents 111, 112 and 113 in advance, it can issue a traverse request only once to the system 10 and more specifically the API 15 in the system 10. The client 20 has only to notify the API 15 of only a combination of the node ID of a node retrieved by the XPath retrieval (XQuery retrieval), which is considered to be the node ID of a base point node, with the direction of movement in the XMLDB 11 with the base point node as a base point. After that, the API 15 has only to issue traverse requests corresponding to the traverse requests 603, 605 and 607 in sequence to the request processing unit 12.

In the above embodiment, the uppermost nodes (“book” nodes) of the XML documents 111, 112 and 113 are managed as child nodes of the uppermost node (“bib” node) of the virtual XML document 110. However, the actual XML documents stored in the XMLDB 11 can be categorized according to, e.g., a document type. A new node unique to each document type can be prepared and managed as a child node of the “bib” node. Further, the uppermost node of the XML documents of the document type can be managed as a child node of the new node. A traverse retrieval can thus efficiently be performed for a plurality of XML documents of the same document type. The document type can be categorized as, for example, a major-category type, a middle-category type and a minor-category type and their corresponding major-category type, middle-category type and minor-category type nodes can be prepared. The XML documents can thus be managed as partial trees of the following tree structure: “bib” node→major-category type node→middle-category type node→minor-category type node→uppermost nodes.

As described above, the client 20 simply issues a traverse request to the system 10 as a retrieval request to designate a base point node corresponding to a base point for retrieval and a location relative to the base point node. The system 10 can thus perform a traverse process to move a current node from one of nodes in the XMLDB 11 designated as the base point node to another one of the nodes in accordance with relative location information of the traverse request. Accordingly, data of a traverse destination node can be acquired. In this system 10, even though a retrieval condition is so complicated that it cannot be designated by a query language such as XPath, data can be retrieved by simply designating a base point node and a location relative to the base point node. In other words, the current node can freely move to all the nodes in the XMLDB 11.

The XMLDB 11 manages a plurality of structured documents as partial trees of one virtual structured document. A traverse process can thus be performed to move the current node, from the node of a document to that of another document in the XMLDB 11. The current node can freely move to all the nodes in the XMLDB 11 based on the parent-child and sibling relationship. A retrieval with no location pass descriptions indicative of the absolute location in the XMLDB 11A, such as a traverse retrieval for a plurality of documents and a retrieval of necessary data only, can be performed.

According to the present embodiment, the current node can freely move from an arbitrary base point node to its parent, child, preceding-sibling or following-sibling node in the structured document database. Therefore, data of a target node can easily be acquired from the structured document database.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A structured document retrieval system comprising:
a structured document database which manages a structured document by a tree structure including a plurality of hierarchical nodes;
means for receiving a traverse request from a client, the traverse request including base point node designation information to designate one of nodes in the structured document database as a base point node corresponding to a base point for retrieval and relative location information to designate a location of a traverse destination node relative to the base point node; and
traverse processing means for performing a traverse process to move from the one of nodes designated by the base point node designation information to another one of the nodes in accordance with the relative location information, and acquiring data corresponding to the traverse destination node from the structured document database.

2. The structured document retrieval system according to claim 1, wherein the relative location information of the traverse request includes direction information to designate one of parent, child, preceding-sibling and following-sibling nodes with respect to the base point node as a traverse direction, and the traverse processing means moves from the one of nodes designated by the base point node designation information to the one of parent, child, preceding-sibling and following-sibling nodes designated by the direction information.

3. The structured document retrieval system according to claim 1, further comprising:
means for receiving a location pass designation retrieval request from the client, the location pass designation retrieval request including a location pass as a retrieval condition, the location pass indicating a location of a node to be retrieved in the tree structure; and
retrieval processing means for retrieving a node designated by the location pass included in the received location pass designation retrieval request from the structured document database to acquire a node identifier corresponding to the node designated by the location pass from the structured document database.

4. The structured document retrieval system according to claim 3, wherein the traverse request includes the acquired node identifier as the base point node designation information.

5. The structured document retrieval system according to claim 3, further comprising request processing means for upon receiving a retrieval request from the client, determining which of the traverse request and the location pass designation retrieval request corresponds to the retrieval request, and sending the retrieval request to the traverse processing means if the retrieval request is the traverse request and sending the retrieval request to the retrieval processing means if the retrieval request is the location pass designation retrieval request.

6. The structured document retrieval system according to claim 1, wherein the structured document database stores a plurality of structured documents as partial trees of one virtual structured document.

7. The structured document retrieval system according to claim 6, wherein the structured document database stores structure information indicating a parent node, a child node, a preceding-sibling node and a following-sibling of each of nodes corresponding to elements of a tree structure of the virtual structured document, and the traverse processing means performs the traverse process in accordance with the structure information.

8. A method of retrieving a structured document from a structured document database which manages a structured document by a tree structure including a plurality of hierarchical nodes, the method comprising:
retrieving a node designated by a location pass, which indicates a location of a node to be retrieved in the tree structure, from the structured document database if a client issues a location pass designation retrieval request including the location pass as a retrieval condition;
returning the retrieved node to the client as a retrieval result obtained by the location pass designation retrieval request;
performing a traverse process of moving a current node from one of nodes in the structured document database, which is designated as a base point node by base point node designation information to designate a node obtained from the retrieval result as a base point node, to another one of the nodes in accordance with relative location information to designate a location of a traverse destination node relative to the base point node if the client issues a traverse request including the base point node designation information and the relative location information, and acquiring data corresponding to the traverse destination node from the structured document database; and
returning the data corresponding to the traverse destination node acquired by the traverse process as a retrieval result obtained by the traverse request.

9. The method according to claim 8, wherein the relative location information of the traverse request includes direction information to designate one of parent, child, preceding-sibling and following-sibling nodes with respect to the base point node as a traverse direction, and the traverse process performing includes determining which of the parent, child, preceding-sibling and following-sibling nodes is a node to which a current node moves from the base point node designated by the base point node designation information, in accordance with the direction information.

10. The method according to claim 9, wherein the structured document database stores a plurality of structured documents as partial trees of one virtual structured document.

11. The method according to claim 10, wherein the structured document database stores structure information indicating a parent node, a child node, a preceding-sibling node and a following-sibling of each of nodes corresponding to elements of a tree structure of the virtual structured document, and the traverse process performing includes specifying a node to which the current node moves from a base point node designated by the traverse request, based on the base point node, a result of the determination and the structure information.

12. A program that is stored in a computer-readable medium to cause a computer to retrieve a structured document from a structured document database which manages a structured document by a tree structure including a plurality of hierarchical nodes, the program comprising:
causing the computer to retrieve a node designated by a location pass, which indicates a location of a node to be retrieved in the tree structure, from the structured document database if a client issues a location pass designation retrieval request including the location pass as a retrieval condition;
causing the computer to return the retrieved node to the client as a retrieval result obtained by the location pass designation retrieval request;
causing the computer to perform a traverse process of moving a current node from one of nodes in the structured document database, which is designated as a base point node by base point node designation information to designate a node obtained from the retrieval result as a base point node, to another one of the nodes in accordance with relative location information to designate a location of a traverse destination node relative to the base point node if the client issues a traverse request including the base point node designation information and the relative location information, and acquire data corresponding to the traverse destination node from the structured document database; and
causing the computer to return the data corresponding to the traverse destination node acquired by the traverse process as a retrieval result obtained by the traverse request.

13. The program according to claim 12, wherein the relative location information of the traverse request includes direction information to designate one of parent, child, preceding-sibling and following-sibling nodes with respect to the base point node as a traverse direction, and the traverse process includes causing the computer to determine which of the parent, child, preceding-sibling and following-sibling nodes is a node to which a current node moves from the base point node designated by the base point node designation information, in accordance with the direction information.
